(19) United States
(12) Patent Application Publication
(10) Pub. No.: US 2003/0061049 A1
(43) Pub. Date: Mar. 27, 2003

(54) Synthesized speech intelligibility enhancement through environment awareness

(75) Inventor: Gamze Erten, Okemos, MI (US)

Correspondence Address: BROOKS & KUSHMAN, 1000 TOWN CENTER 22ND FL, SOUTHFIELD, MI, 48075

(73) Assignee: Clarity, LLC, Troy, MI

(21) Appl. No.: 10/231,759

(22) Filed: Aug. 29, 2002

Related U.S. Application Data
(60) Provisional application No. 60/315,785, filed on Aug. 30, 2001.

(51) Int. Cl. G10L 13/08

(52) U.S. Cl. 704/260; 704/258

(57) ABSTRACT

Synthesized speech is enhanced by listening to the acoustic background into which the synthesized speech is delivered and adjusting parameters of the synthesized speech accordingly. In one embodiment, text is synthesized into speech based on at least one noise parameter determined from the environment into which the synthesized speech is delivered. In another embodiment, parameters for a filter modifying the synthesized signal are determined based environmental noise.

### CROSS-REFERENCE TO RELATED APPLICATIONS

This application claims the benefit of U.S. provisional application Serial No. 60/315,785 filed Aug. 30, 2001, which is incorporated herein by reference in its entirety.

### BACKGROUND OF THE INVENTION

1. Field of the Invention

This invention relates to the enhancement of synthesized speech for increasing listener intelligibility.

2. Background Art

The general public is becoming increasingly accustomed to synthesized speech. Many call centers, such as used for airline reservation lines, now use automated speech recognition and synthesis. Synthesized speech is inherently more difficult to understand than natural speech, even when listened to through a speaker placed right at or very close to the ear. Synthesized speech becomes less intelligible when it is delivered into a speaker that is further away from the ear than, for example, the earpiece of a telephone or earphones. Environmental noise further exacerbates the problem.

When humans communicate with one another in a noisy environment, they tend to change one or more characteristics of their speech such as, for example, volume, pitch, timing and the like. Humans may also pause or repeat parts of their speech when it is clear that their voices will not be, or have not been heard.

Current speech synthesis systems, on the other hand, are not aware of their environment. As synthesized speech systems start to be deployed in noisy environments, such as inside vehicles for information delivery, this problem will be a significant obstacle to customer acceptance. What is needed is to increase intelligibility by making the synthesis system aware of environmental conditions, such as noise parameters and environmental acoustics.

An additional dimension to the problem is the growing number of individuals whose hearing is impaired due to age or health conditions, as well as individuals who wear hearing aids. Some consideration has to be given to making synthesized speech accessible to these individuals, who will be increasing isolated due to the reduced human presence at the point of delivery for many help or customer service functions.

### SUMMARY OF THE INVENTION

Enhancement of synthesized speech is essential for successful deployment of voice-activated software, especially noisy environments and public places such as cars, airports, restaurants, shopping malls, outdoor locations, and the like. Synthesized speech is enhanced by listening to the acoustic background into which the synthesized speech is delivered and adjusting parameters of the synthesized speech accordingly.

The present invention provides a method for synthesizing speech in an environment. Text to be converted into an audible speech signal is received. The audio content of the environment is sensed. At least one noise parameter is determined based on the sensed audio content. The text is converted into a speech signal based on the noise parameter.

In embodiments of the present invention, the text is modified based on commands that can change volume, pitch, rate of speech, pause durations, and the like.

In another embodiment of the present invention, spectral characteristics of a filter are determined based on the noise parameter. The speech signal is then processed with the filter.

In still another embodiment of the present invention, at least one noise parameter is determined only when the presence of speech is not detected in the sensed audio content.

In yet another embodiment of the present invention, at least one command is extracted from the detected speech. The conversion of text into speech is modified based on the at least one extracted command. Modifications can include playback operation, user adjustment to sound parameters, selection of text files, and the like.

In other embodiments of the present invention, the noise parameter can include one or more of noise level, noise spectrum, noise periodicity, and the like.

An automotive sound system is also provided. At least one sound generator plays sound into a body compartment. A memory holds at least one text file. A speech synthesizer converts text from each text file into a speech signal and provides the speech signal to each sound generator. At least one acoustic transducer senses sound in the body compartment. Control logic determines at least one noise parameter from sound sensed in the body compartment and generates at least one command based on the determined noise parameter. Each command modifies the conversion of text into speech by the speech synthesizer.

In an embodiment of the present invention, a server serving text files through a wireless transmitter. A wireless receiver receives the text files transmitted from the server and places the received text files into the memory.

A method for synthesizing speech to be acoustically delivered into an environment is also provided. Acoustic noise in the environment is analyzed. Parameters for a filter to improve intelligibility of synthesized speech are generated based on the environmental noise. A text stream is converted into a speech signal. The speech signal is then passed through the filter.

### BRIEF DESCRIPTION OF THE DRAWINGS

FIG. 1 is a schematic diagram illustrating remote transmission of speech related information according to embodiments of the present invention;

FIG. 2 is a block diagram illustrating improved speech synthesis according to embodiments of the present invention;

FIG. 3 is a block diagram illustrating environmentally aware speech synthesis according to an embodiment of the present invention; and

FIG. 4 is a block diagram illustrating environmentally aware synthesized speech delivery according to an embodiment of the present invention.

### DETAILED DESCRIPTION OF THE PREFERRED EMBODIMENT(S)

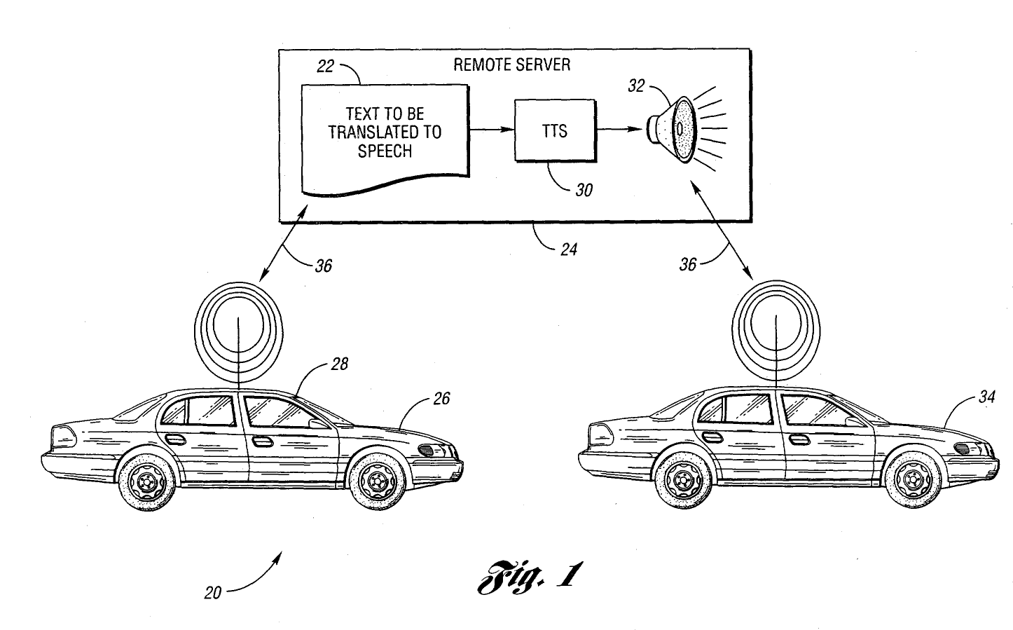

Referring to FIG. 1, a schematic diagram illustrating remote transmission of speech related information according to embodiments of the present invention is shown. Speech synthesis systems can be implemented via one, or as a hybrid, of two approaches. First, speech synthesis may be carried out on a remote server and the synthesized speech sent to or acquired by the delivery point. Second, text data may be delivered to or acquired by the delivery point, where speech is synthesized and delivered. Each of these two speech synthesis approaches has advantages and disadvantages. The first approach, namely speech synthesis carried out on a remote server, removes the computational burden of speech synthesis from the in-vehicle computer or handheld device. However, this method requires greater bandwidth to download the speech file which will contain considerably more bits, say 50-1000 times more, than the text version of the same information. This method may also allow for a more sophisticated speech synthesis system. The situation is reversed with the second approach. More computational resources are needed on the vehicle computer or the handheld device, but the bandwidth demand is lower.

The present invention applies to intelligibility enhancements in both cases, namely for both on-going synthesis of a text file and an already synthesized audio file. Regardless of which of the approaches is used in the delivery of synthesized speech, environmental awareness is built into the delivery point since the environmental conditions are specific and unique to that environment.

Corresponding to the two circumstances outlined above, the invention implements environmentally aware speech synthesis and synthesized speech delivery. Both deliver optimum intelligibility to the user. The first aspect may be referred to as Environmentally Aware Speech Synthesis System (EASSS). EASSS integrates the method of the invention into the speech synthesis process itself. This implies that the speech synthesis is occurring during the delivery of the synthesized speech. The second aspect may be referred to as Environmentally Aware Synthesized Speech Delivery (EASSD). EASSD integrates the method of the invention after speech has been synthesized.

This distinction is further illustrated in FIG. 1 in the context of an automotive telematics system, shown generally by 20. Telematics is defined as the use of computers to receive, store and distribute information or training materials at a distance over a telecommunications system. Some examples of telematics are email, worldwide web, videoconferencing, data conferencing, and the like. Access to the world wide web from the vehicle as well as data conferencing brings all kinds of information services, media content and navigation capability to the driver.

ASCII text file 22 is downloaded from remote server 24 and synthesized on board vehicle 26. This is a candidate for the EASSS. EASSS operates during speech synthesis; the pertinent parameters of the speech synthesis process are modified using feedback from the environment, such as body compartment 28, to which the synthesized speech is being delivered. In an alternative embodiment, text file 22 is converted by text-to-speech converter 30, associated with remote server 24, into audio file 32. Audio file 32 is downloaded to vehicle 34. The speech synthesis process in this case is carried out without any knowledge of the environment into which the synthesized speech is going to be delivered. This is a candidate for the EASSD. EASSD in this case will modify the synthesized speech characteristics during or immediately prior to actual delivery (or playback) for enhanced intelligibility.

Note that, in both cases, the download of information to the vehicle may be accomplished via a wireless link, illustrated by 36. The text or audio file may also be brought onto the vehicle via an alternate link, such as a laptop, handheld computer, audio player, a diskette or other storage medium, as well as through another information portal supported by the in-vehicle computer or entertainment system. Furthermore, speech synthesis or synthesized speech enhancement, as well as playback can take place on many different platforms on board the vehicle.

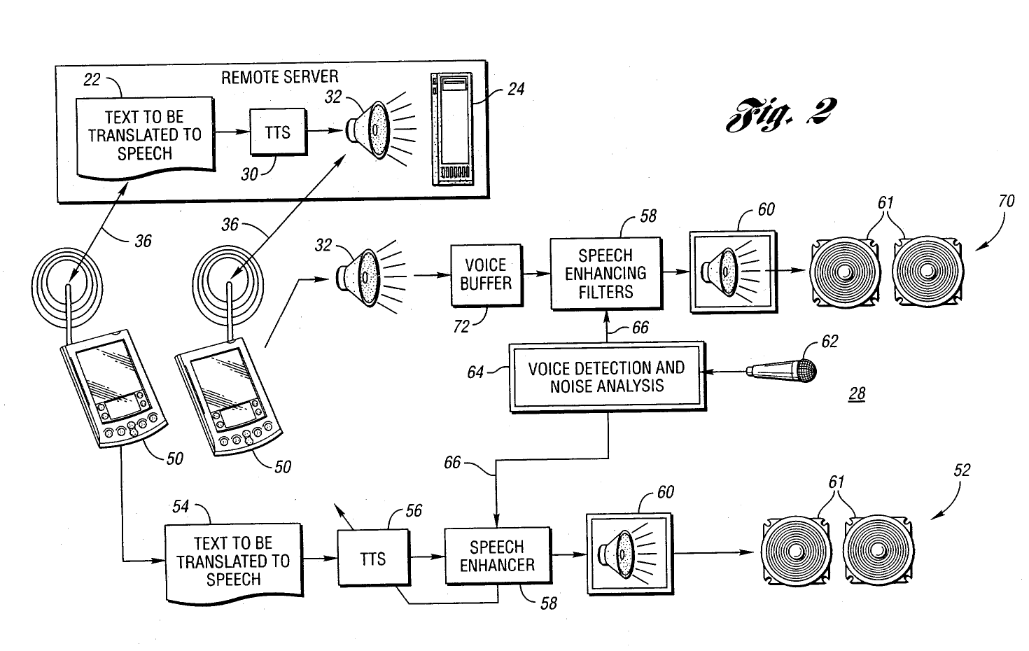

Referring now to FIG. 2, a block diagram illustrating improved speech synthesis according to embodiments of the present invention is shown. In FIG. 2, Internet ready personal digital assistant (PDA) 50 is shown as the link to remote server 24. In this embodiment, PDA 50 has been interfaced to the audio system of vehicle 26, 34, such as via a cradle. It is also possible that vehicle 26, 34 is equipped with a cradle into which can be plugged a handheld portable communication device such as, for example, a cellular phone, personal digital assistants (PDA), handheld computers, or the like. This way, the speech synthesis can make use of an existing infrastructure for communications.

The EASSS, shown generally by 52, receives a text file 22. In this embodiment, wireless transmitter 36 sends text file 22 to wireless receiver 50, where text file 22 is stored in memory 54. Text-to-speech (TTS) converter 56 reads text file 22 from memory 54 and generates a speech signal which is filtered by speech enhancer 58 to produce audio signal 60. Audio signal 60 is played into environment 28, such as a vehicle interior cavity, through speakers 61.

Synthesized speech signal 60 is greatly enhanced through the use of sound transducer 62 in environment 28. Voice detection and noise analysis unit 64 receives a sound signal from transducer 62 and generates one or more parameters 66 indicative of noise in environment 28. These parameters may be used to affect speech enhancer filter 58, TTS converter 56, or both. In addition, parameters 66 may be used to generate commands that are read by TTS converter 56. These commands may be written into memory 54.

EASSS can change virtually all parameters of synthesized speech such as volume, pitch, speaker, rate of speech, pauses between words, dynamic dictionaries that allow for different phonetic translations, and the like. Having the synthesis process under control of speech intelligibility enhancement procedures allows for many parameters to be controlled. One of these parameters is the speaker. Many text-to-speech engines provide at least one male and at least one female voice. The noise conditions under which the male or the female (or other voices) are preferred can be determined from an intelligibility point of view. The EASSS can then decide to switch from voice to voice—preferably in paragraph breaks. Moreover, pitch modification becomes far more straightforward during the speech synthesis process than afterwards. Having the synthesis process under control of speech intelligibility enhancement procedures also allows for modifications of insertion of intonation and other cues can be carried out by adding command sequences to the text itself that denote verb/noun/adverb/adjective/past participle so that the words like read are pronounced properly. This will no doubt improve intelligibility for all environments, including noisy ones.

The EASSD is shown generally by 70. In this embodiment, speech file 32 has already been synthesized on remote server 24. Speech file 32 may consist of information from a call center or voice portal such as from airline reservations customer centers; voice portals to the Internet, such as BeVocal.com and TellMe.com; or the recipient's email messages, which have been translated to audible format already. Using buffer 72 to hold speech file 32 that is streaming from server 24, it is quite straightforward to implement many of the same modifications on synthesized speech as with EASSS. Buffer 72 feeds speech enhancing filter 58 which has filter parameters based on noise parameters 66 generated by voice detection and noise analysis unit 64. For example, pitch modification requires filters, and some of the other modifications, such as changing the pauses between words can be accomplished by a set of simple algorithms that establish word boundaries.

In both EASSS and EASSD systems, voice detection and noise analysis guide the speech enhancement process. An echo canceller that removes the synthesized speech from the noise analysis can be embedded. Finally, an automated audio playback system carries out audio playback functions. EASSS incorporates a speech synthesis engine in addition to these elements. All of these elements are further described below.

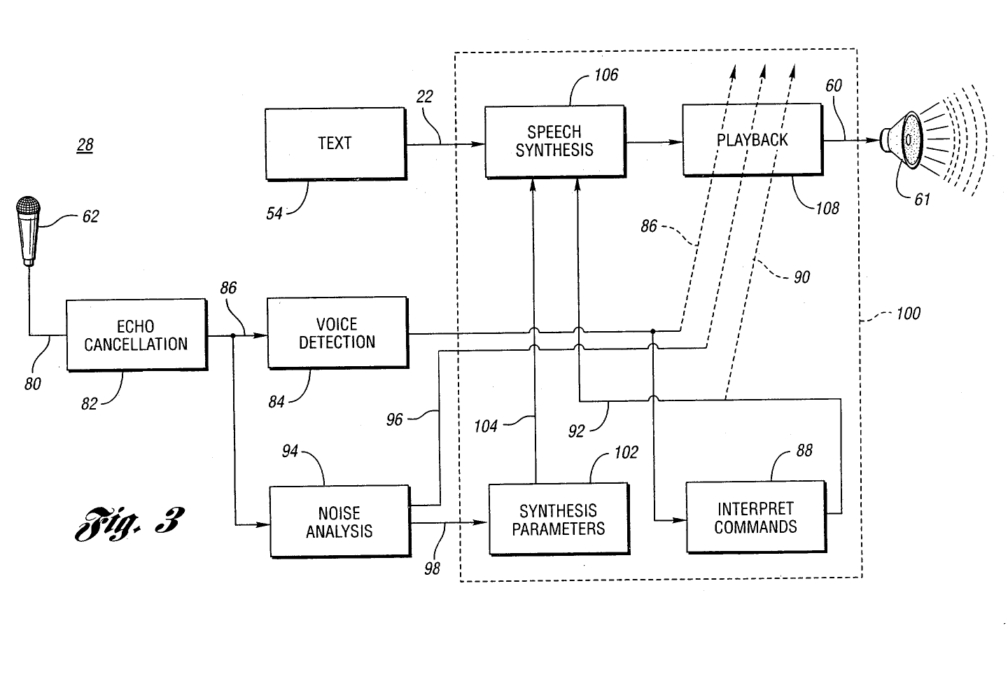

Referring now to FIG. 3, a block diagram illustrating environmentally aware speech synthesis according to an embodiment of the present invention is shown. Audio transducer 62 picks up sound from environment 28. Because an open-air acoustic path exists between the loudspeaker 61 that plays back the synthesized speech and the microphone 62, the synthesized speech will be picked up by the microphone 62. Synthesized speech output from the loudspeaker 61 fills the entirety of the enclosure 28 and, via many paths of reflections, reaches the microphone 62. This acoustically echoed speech signal will make noise analysis and voice detection using the microphone signal 80 more difficult.

Acoustic echo cancellation (or AEC) is a technique traditionally used in telecommunications to electronically cancel echoes before they are transmitted back over the network. This technique can be applied to the system of this invention, as well. To cancel echoes, AEC 82 must learn the character of the open-air path between the loudspeaker 61 and microphone 62. This path is a function of not only the loudspeaker 61 and microphone 62, but also of their placement within the room 28 and the room's acoustics, including its construction materials, dimensions, furnishings and their locations, and the room's occupants. Many methods for this are available in the art of signal processing. The most attractive are adaptive filters that adapt to the changing room environment. The most common type of adaptive algorithm is based around the least mean square (LMS) algorithm.

Voice detection is carried out by voice detector 84, which receives the output 86 from echo cancellation 82. Voice detection is the process of determining whether or not a certain segment of the audio signal 86 contains a voice signal. By voice signal, what is usually meant is the voice signal of the user of a speech activated command and control system, or a voice recording, coding, and/or transmitting system such as a cellular phone. Many voice detection methods are available in the art. Some, such as those used in the voice detection mechanisms for cellular telephony, have been standardized and are available as software modules.

Voice detector 84 should be able to tell the voice of the user from the voice of the synthesized speech signal. Using echo cancellation removes most of the synthesized speech from the voice signal picked up by the microphone or the microphone array, and makes this an easier task.

Once the voice of the user is detected, the synthesized speech delivery can be paused to avoid talking over the voice of the user, such as by control signal 86. The user's voice signal can be analyzed by a speech recognition system, such as command interpreter 88, to interpret any voice commands the user may have uttered. For example the user may have given a voice command to pause the speech synthesis. Any synthesized speech that may have been delivered while the user was speaking can later be repeated, unless of course, the command given by the user makes this unnecessary or undesirable. Command interpreter may generate control signals 90 to affect playback and may also generate synthesis control signals 92 affecting the synthesis process.

Elimination of noise from an audio signal leads to better voice detection. If noise mixed into the voice signal is reduced, while eliminating none or little of the voice component of the signal, concluding whether a certain part of the signal contains voice or not is more straightforward. This implies that voice detection may be preceded by a noise cancellation system.

Identification of the user's voice signal goes hand in hand with the identification of noise in the environment. Noise analysis is carried out in noise analyzer 94, which receives audio signal 86. Analysis of the general background noise can be carried out best when the user is silent. However, noise analysis can be continuous, as well. Noise characteristics include, but are not limited to, noise level, noise spectra, periodicity of noise, detection of intermittent noise, and the like. These characteristics are then used to modify the characteristics of the synthesized speech, such as loudness, based on a desired signal to noise ratio level. This modification may be accomplished by affecting playback, as with control signal 96, or by affecting speech synthesis parameters, such as with control signal 98.

Many noise analysis methods are available in the art. Some, such as those used in the noise cancellation mechanisms for cellular telephony, have been standardized and are available as software modules. One method, called voice extraction, provides for an estimate for voice and noise signals. This method typically requires two or more microphones. This method is described in

Speech synthesis engine 100 generates speech signal 60 from text held in memory 54. Many speech synthesis engines make it possible to modify characteristics of the synthesized speech. Parameters of synthesized speech that can commonly be modified include volume, pitch, speaker, rate of speech, pauses between words, dynamic dictionaries that allow for different phonetic translations, and the like.

Insertion of intonation and other cues can also be carried out by embedding commands into text 22 itself to change volume, change speech rate, change wait period between sentences, denote verb/noun/adverb/adjective/past participle so that the words like read are pronounced properly, add beeps, add pauses of variable length, use phonetic input, and the like. These commands apply towards enhancement of speech synthesis whether or not environmental cues such as noise level or presence of voice are present or not. This category of modifications, which could be accomplished by simple commands if the text file is available, requires natural language processing to determine where the nouns, verbs, adjectives, and adverbs are in the stream of synthesized sentences. One potential solution is to have access to the original text file—in addition to the streaming audio of the synthesized speech. This can by accomplished with a hybrid of EASSS and EASSD.

Parameter generator 102 produces parameters 104 for speech synthesizer 106. Filters that enhance synthesized speech intelligibility may involve one or more of frequency shaping, such as enhancement of desired frequencies to raise these frequencies above the noise; frequency shifting to avoid noise spectra; phase modification; pitch modification; buffering and delivering at selected times, such as when noise is low; compression or expansion of phonemes; power normalization; automatic gain control; and the like. Such filters are well known in the art and there design depends on a wide variety of parameters including expected ranges of voice parameters, expected ranges of noise parameters the environment, user characteristics, and the like.

Playback section 108 may provide a wide variety of support functions, such as move forward or backward, stop, play, pause, append text while synthesis is ongoing, and the like. Some simple rules can be used for the appropriate audio tape player function, such as:

1. Turn up or down the volume based on the noise level.

2. Pause the synthesized speech when the user's voice is detected.

3. Pause the synthesized speech when a very loud noise is detected, such as a horn, siren, passing truck that makes conversation in the vehicle impossible, and the like.

4. Back up several words after a pause and repeat those when streaming audio is resumed.

Furthermore, given multiple speaker systems, redistribution between speakers, which emulate various types of sound immersion or echo reduction may help intelligibility.

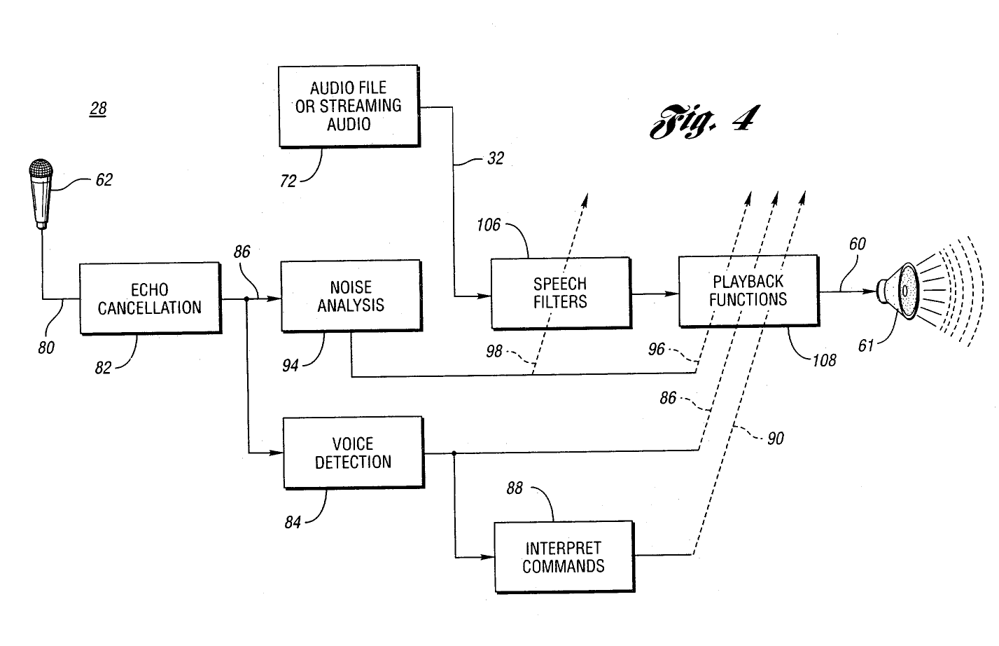

Referring now to FIG. 4, a block diagram illustrating environmentally aware synthesized speech delivery according to an embodiment of the present invention is shown. The EASSD includes echo cancellation 82 removing synthesized speech from microphone signal 80 to produce audio signal 86. Voice detection 84 detects the presence of a voice in audio signal 86. This detection may be used to control noise analysis 94 so that no analysis occurs during periods of speech. Command interpreter 88 uses detected speech from voice detector 84 to interpret commands. Both voice detector 84 and command interpreter 88 may control playback functions 108.

Noise parameters 98 from noise analyzer 94 are used to generate parameters for speech filter 106. Speech filter 106 processes audio file 32, which contains synthesized speech, from buffer 72. Playback functions may be implemented following speech filters 106, as shown, as part of buffer 72, or both.

The novel speech enhancement techniques of this invention will expand the domain of voice related applications. One near term commercial application is automotive telematics, where keeping the hands of the driver on the driving wheel and eyes of the driver on the road means an all-speech interface. The system will also on making a key emerging technology, namely synthesized speech, accessible by more people—including these who have hearing difficulties and those who wear hearing aids. It is hoped that this will promote the inclusion of these individuals, a growing number of which are senior citizens and the elderly, who are at risk of being increasing isolated due to the reduced human presence at the point of delivery for many community help and customer service functions.

Commercial uses of the envisioned products include delivering synthesized speech to noisy environments. Applications are especially attractive for small mobile pocketsize and/or wearable computers. These devices, especially those that are also equipped with communication capabilities will impact both work and play in profound ways in the coming decade. Being a low cost environmentally aware speech synthesis system, the invention and related technologies can also be inserted into emerging automotive telematics devices and services towards in-vehicle infotainment and communications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for synthesizing speech in an environment, the method comprising:
receiving text to be converted into an audible speech signal;
sensing the audio content of the environment;
determining at least one noise parameter based on the sensed audio content; and
converting the text into a speech signal based on the at least one noise parameter.

2. A method for synthesizing speech as in claim 1 wherein converting the received text is based on a command to change volume of converted text in the speech signal.

3. A method for synthesizing speech as in claim 1 wherein converting the received text is based on a command to change pitch of converted text in the speech signal.

4. A method for synthesizing speech as in claim 1 wherein converting the received text is based on a command to change rate of speech of converted text in the speech signal.

5. A method for synthesizing speech as in claim 1 wherein converting the received text is based on a command to change pause duration of converted text in the speech signal.

6. A method for synthesizing speech as in claim 1 wherein converting the text comprises writing a command into the text prior to conversion, the command based on the at least one noise parameter.

7. A method for synthesizing speech as in claim 1 further comprising:
determining spectral characteristics of a filter based on the determined at least one noise parameter; and
processing the speech signal with the filter.

8. A method for synthesizing speech as in claim 1 further comprising:
detecting the presence of speech in the sensed audio content; and
determining at least one noise parameter only when the presence of speech is not detected.

9. A method for synthesizing speech as in claim 1 further comprising:
detecting the presence of speech in the sensed audio content;
extracting at least one command from the detected speech; and
modifying the conversion of text into speech based on the at least one extracted command.

10. A method for synthesizing speech as in claim 1 further comprising determining between one of at least two phonetic translation dictionaries used for converting the modified text into a speech signal based on the at least one determined noise parameter.

11. A method for synthesizing speech as in claim 1 wherein the at least one noise parameter comprises a noise level.

12. A method for synthesizing speech as in claim 1 wherein the at least one noise parameter comprises a noise spectrum.

13. A method for synthesizing speech as in claim 1 wherein the at least one noise parameter comprises an indication of noise periodicity.

14. An automotive sound system comprising:
at least one sound generator operative to play sound into a body compartment;
a memory operative to hold at least one text file;
a speech synthesizer in communication with the memory and each speaker, the speech synthesizer converting text from each text file into a speech signal and providing the speech signal to each sound generator;
at least one acoustic transducer for sensing sound in the body compartment; and
control logic in communication with each acoustic transducer and the memory, the control logic determining at least one noise parameter from sound sensed in the body compartment and generating at least one command based on the determined at least one noise parameter, each command modifying the conversion of text into speech by the speech synthesizer.

15. An automotive sound system as in claim 14 wherein the generated command changes an amplitude of the speech signal.

16. An automotive sound system as in claim 14 wherein the generated command changes pitch of the speech signal.

17. An automotive sound system as in claim 14 wherein the generated command changes speech rate of the speech signal.

18. An automotive sound system as in claim 14 wherein the generated command changes pause duration of the speech signal.

19. An automotive sound system as in claim 14 wherein the generated command is inserted into the memory.

20. An automotive sound system as in claim 14 wherein the control logic determines at least one noise parameter only when the presence of speech is not detected from sound sensed in the body compartment.

21. An automotive sound system as in claim 14 further comprising a programmable filter filtering the sound signal before the sound signal is played into the body compartment, wherein the control logic programs the filter based on the determined at least one noise parameter

22. An automotive sound system as in claim 14 further comprising:
a server serving text files;
a wireless transmitter in communication with the server; and
a wireless receiver in communication with the memory, the wireless receiver receiving text files transmitted from the server and placing the received text files into the memory.

23. A method for synthesizing speech to be acoustically delivered into an environment, the comprising:
analyzing the acoustic noise in the environment;
generating parameters for a filter to improve intelligibility of synthesized speech based on the environmental noise;
converting a text stream into a speech signal; and
passing the speech signal through the filter.
